(19) United States
(12) Patent Application Publication
(10) Pub. No.: US 2005/0136547 A1
(43) Pub. Date: Jun. 23, 2005

(54) Polymer reaction and quality optimizer

(75) Inventors: Frank P. Larmon, Amite, LA (US); Todd M. Hess, Chagrin Falls, OH (US)

Correspondence Address: Michael M. Rickin, Esq.;ABB Inc., Legal Department - 4U6, 19801 Euclid Avnue, Wickliffe, OH, 44092-1898, US

(73) Assignee: ABB Inc.

(21) Appl. No.: 10/744,255

(22) Filed: Dec. 22, 2003

(51) Int. Cl. G01N 35/08

(52) U.S. Cl. 436/55

(57) ABSTRACT

A polymer reaction and quality optimizer that optimally determines all factors affecting the finished polymer prior to initiating the batch, uses the optimized parameters in setting up and starting the batch, in an on-line procedure for correcting assumptions made in the optimal determination based upon measurement responses from batch startup, and in an on-line procedure that periodically executes to determine and adapt reactor temperature control profiles across the remaining life of the batch to achieve the desired polymer properties and optimal polymer yield. The reaction and quality optimizer also determines at the end of a batch using several criteria if any of the equipment used within the process such as the reactor should be cleaned.

### FIELD OF THE INVENTION

This invention relates to the production of polymers such as polyvinyl chloride (PVC) and more particularly to the optimization of the process for producing polymers and improving the quality of the polymer produced by that process.

Description of the Prior Art

PVC is one of the oldest polymers and the second largest thermoplastics in terms of volume manufactured in the world. This widespread use arises from PVC's high degree of chemical resistance and its truly unique ability to be mixed with additives to give a large number of reproducible compounds having a wide range of physical, chemical, and biological properties. This makes PVC a versatile choice over other plastic materials.

More than 75% of the world's PVC resins are produced by the batchwise aqueous suspension precipitation polymerization process. Due to the number of variables involved, such as the amount of monomer charged, monomer impurities, initiator charge and properties, temperature control profile, etc., the process is extremely complex and it is difficult to achieve an optimum operation of the process.

The suspension polymerization process uses a reactor which includes an agitator to facilitate improved monomer/water dispersion. Most current reactors are water-jacketed and lined with glass or stainless steel to minimize polymer buildup on the walls. Typically, a reflux condenser is also used within the process to assist with the removal of heat generated from the highly exothermic polymerization reactions. The process flowsheet of a typical batch suspension PVC reactor 1 is shown in FIG. 1. Other types of PVC polymerization processes include mass polymerization and emulsion polymerization.

A vinyl chloride monomer (VCM) which includes recovered vinyl chloride monomer (RVCM) 2 is used in the process. The VCM and included RVCM 2 are first finely dispersed in process water 13 by vigorous agitation using agitator 3. A small amount of primary and/or secondary suspension agents or dispersants 4 such as partially saponified polyvinyl alcohol (PVA) or polyvinyl acetates, are added to control coalescence of the growing grains as a protective coating of polymer is eventually formed. Viscosity changes can be managed with conversion and also injection water, ensuring effective heat transfer to the reactor walls; however, this becomes less important for systems with reflux condensers 5 (since this is where 80% of heat removal occurs).

Polymerization is induced by the addition of oil- or monomer-soluble initiators 6 used either alone or in combination with each other. Materials such as those coming from the diacyl peroxide, peroxydicarbonate, azo initiator or alkyl peroxyester groups are initiators commonly employed in suspension or mass polymerization of VCM. Initiators may also be added by batch or while not so common today at a controlled rate during the polymerization process. The reaction takes place in the coalesced monomer droplets. The reactor's contents are heated to the required temperature by either steam or hot water 7. Once the initiator(s) 6 begin to decompose into free radicals, polymerization commences. The heat of polymerization is transferred from the monomer droplets to the aqueous phase and then to the reactor wall, which is cooled by water 8 flowing through the reactor's jacket.

The reactor design includes a cooling jacket 9 which may or may not provide the means for all heat removal. If the reactor 1 includes a reflux condenser 5, it is typically provided as an upper extension to the reactor for condensing monomer vapor generated in the reactor and refluxing the condensed monomer back into the reactor. The reflux condenser 5 will remove most of the heat. If only a jacket 9 is used, chilled water 8 will normally be used in the jacket 9 unless the cooling jacket 9 is very efficient.

When the free liquid monomer has been consumed, the pressure in the reactor 1 begins to fall as a result of free monomer being consumed in the liquid phase and increased monomer mass transfer from the vapor phase to the polymer phase due to a sub-saturation condition. In industrial PVC production, the reaction is usually stopped when the pressure drops a certain amount. Since PVC is mostly insoluble in its own monomer, once the polymer chains are first generated, they precipitate immediately to form two separate phases in the polymerization droplet (the polymer and an entrapped monomer phase). Reactions continue in both the free liquid monomer phase and the entrapped monomer phase dispersed about the formed polymer. When polymerization is complete, the polymer is in the form of a colloid consisting of spherical particles dispersed in water. If the polymerization conditions are properly chosen through the course of the batch, a polymer having extremely narrow particle-size distributions can be obtained.

Suspension polymerization can be carried to 84% to 88% conversion, under proper pressure and temperature by using oil-soluble initiators. The final conversion determines the finished polymer properties. The reaction temperature is used for molecular weight control. Sometimes, a chain transfer agent may be added to control molecular weight in the free radical polymerization. Polymerization inhibitors may also be used in this system for control of polymerization reactions, kill agents if needed in highly unusual circumstances to immediately stop the reaction and end stop agents at the end of the batch to bring the polymerization reactions to a controlled stop. Typical polymerization times can vary between 3.5 to 6 hours, depending on the molecular weight of the polymer resin being prepared, as well as the heat-removal capacity of the reactor system. After completion of the batch, the mixture (polymer slurry) 11 is transferred to a blow-down vessel (not shown) where unreacted vinyl chloride is recovered. The PVC slurry 11 is then stripped, dried, and stored.

The prior art has dealt mostly with the real-time control of certain parameters within the PVC polymerization process. For example, U.S. Pat. No. 6,106,785 and U.S. Pat. No. 6,440,374 each describe a batch polymerization process controller that uses inferential sensing to determine the integral reaction heat. The integral reaction heat is used to estimate the degree of polymerization which has occurred in the batch reactor. The integral reaction heat can be used in either a feedback mode where it is the direct controlled variable or a feedforward mode where another variable such as reaction temperature is the direct controlled variable. In whatever mode used, the reaction heat tends to be a poor measurement of the degree of polymerization since heats of reaction vary depending upon chain length, the degree of cross-linking and the amount of heat holdup within the reaction vessel which is also affected by heat transfer resistances to the jacket and reflux condenser. Therefore the prior art suffers since it does not provide an ability to backward correlate the degree of polymerization to these other parameters.

Furthermore, the prior art is focused upon maintaining or regulating a particular “desired” value assigned “a priori” to either the integral reaction heat or reaction temperature without focusing upon a better determination of an improved control target of these values based upon a multiple number of other factors. Such factors that can affect the “desired” values include the amount and impurities of monomer charged to the reactor; the amount, time and activity of initiator(s) charged to the reactor; the amount and impurities of water charged to the reactor; the heat exchange coefficients for the jacket and reflux condenser; the remaining time to batch completion; etc. In fact, all parameters will affect the desired temperature target not only for instantaneous control of the reactor but how to best control the reactor over the remaining time of the batch.

In contrast to the polymerization process controller described in the prior art it is desirable to optimally determine all factors affecting the finished polymer prior to initiating the batch, using these optimized parameters in setting up and starting the batch, in an on-line procedure for correcting assumptions made in the optimal determination based upon measurement responses from batch startup, and in an on-line procedure that periodically executes to determine and adapt reactor temperature control profiles across the remaining life of the batch (also estimated by the procedure) to achieve the desired polymer properties and optimal polymer yield. The present invention meets these requirements.

### SUMMARY OF THE INVENTION

In a polymer plant a method that comprises:
creating an initial model of a polymer batch process run in the plant;
characterizing the initial model based on past operation of the batch process; and
using the characterized model to perform dynamic optimization of a batch to be run in the polymer batch process.

In a polymer plant a method that comprises:
collecting data from a batch run in a polymer batch process in the plant; and
performing after the data is collected a dynamic reconciliation and parameter estimation for providing both reconciled data and a tuned model for the process.

In a polymer plant a method that comprises:
collecting data from a batch run in a polymer batch process in the plant for one or more predetermined periods of time;
initializing from the data and a tuned model for the process the state variables of the batch; and
performing on-line optimization of process variables of the batch run in the process.

A polymer plant that comprises:
a computing device for optimizing a batch run in a polymer batch process in the plant, the computing device either:
for determining optimal performance of the polymer batch process by executing one or more optimizations selected from:
a dynamic optimization of a batch to be run in the polymer batch process;
on-line optimization of process variables of a batch run in the process; and
an optimization to determine if any of the equipment used within the process should be cleaned; or for performing after data is collected from a batch run in the process a dynamic reconciliation and parameter estimation for providing both reconciled data and a tuned model for the process.

### DESCRIPTION OF THE DRAWING

FIG. 1 shows a process flowsheet for a typical batch suspension PVC reactor.

FIG. 2 shows a block diagram of how the present invention of the performs its PVC reactor optimization and quality control functions.

FIG. 3 shows a flowchart for the pre-batch off-line optimization phase of the present invention.

FIG. 4 shows the elements of the pre-batch optimization in the flowchart of FIG. 3.

FIG. 5 shows a flowchart for the batch characterization part of the on-line phase of the present invention.

FIG. 6 shows the elements associated with the batch characterization in the flowchart of FIG. 5.

FIGS. 7a and 7b show a flowchart for the on-line optimization of the on-line phase of the present invention.

FIG. 8 shows the elements associated with the on-line optimization in the flowchart of FIG. 7a.

FIG. 9 shows a flowchart for the reactor cleaning optimization of the post batch phase of the present invention.

FIG. 10 shows the elements of the reactor cleaning optimization in the flowchart of FIG. 9.

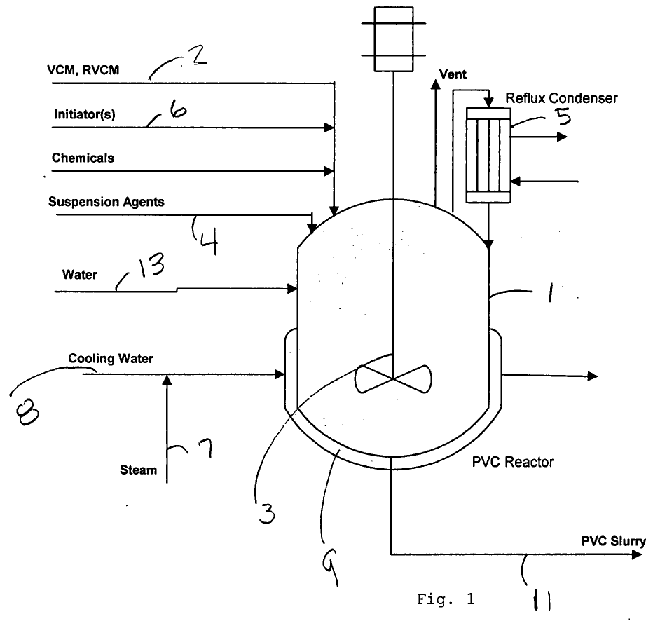

### DESCRIPTION OF THE PREFERRED EMBODIMENT(S)

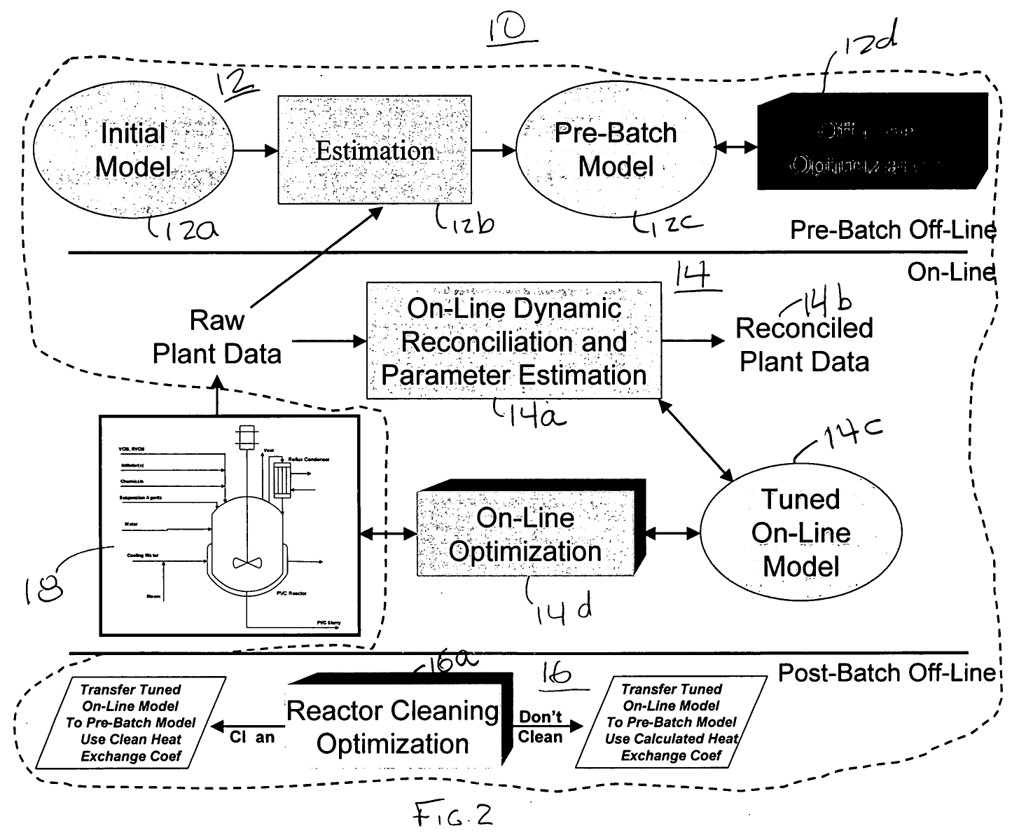

Referring now to FIG. 2, there is shown a block diagram of how the technique 10 of the present invention performs its PVC reactor optimization and quality control functions. The technique of the present invention can be performed in a computing device such as a supervisory computer platform or a distributed control system (not shown) and is divided into three phases, namely pre-batch off-line phase 12, on-line phase 14 and post-batch off-line phase 16 as is shown in FIG. 2.

In pre-batch off-line phase 12 the off-line reaction optimizer is executed to determine how to load the reactor 18 shown symbolically in FIG. 2. Phase 12 starts with an initial model 12a of the PVC reaction process. The initial model 12a is created using one of a number of commercially available process modeling packages. In estimation 12b raw data from the reactor 18 and if available properties from a laboratory analysis from one or more prior PVC batches may be used to characterize the initial model 12a, that is establish the model parameters, to arrive at pre-batch model 12c. Off-line optimization 12d which has many uses is then used to establish the recipe to be used. The existing batch recipe is used if the pre-batch off-line phase 12 is performed weeks before the start of the on-line phase 14. A new or updated recipe for the batch is used if the pre-batch off-line phase 12 is performed just before the start of the on-line phase 14. Off-line optimization may also be used to perform dynamic optimization of more than one batch to be run in the polymer process.

The reactor 18 is loaded using the recommendations of the off-line phase 12. The reactor 18 is started after it is loaded and controlled at the temperature profile provided by the off-line phase 12.

The technique then enters the on-line phase 14 where on-line dynamic reconciliation and parameter estimation 14a is performed. Up to this point in the technique assumptions on model parameters, efficiencies of initiator(s), VCM and water impurities, etc. have been made in the recipe. On-line dynamic reconciliation and parameter estimation 14a is used to correct for errors in these assumptions. Since the present invention is concerned with dynamic reconciliation and parameter estimation the corrections are performed by 14a only after the process has run for some time collecting measurements from its start, for example, fifteen minutes or one half hour. The technique of the present invention can perform this dynamic correction either only once or on scheduled cycles. Measurements of the PVC reaction process in operation are taken and are used in the on-line dynamic reconciliation and parameter estimation 14a.

The end results of the dynamic reconciliation and parameter estimation is reconciled plant data 14b and a tuned on-line model 14c. That model is used in an on-line optimization 14d of the process as for example to check for and control run away temperatures in reactor 18 and determine the end time of the batch. The on-line optimization may be performed one time or may be periodically scheduled over the course of the batch.

Once the batch is complete the technique 10 enters the post-batch off-line phase 16 where the reactor cleaning optimizer 16a is executed to determine if any of the equipment used with the batch such as reactor 18 should or should not be cleaned. If optimizer 16a determines that the reactor 18 should not be cleaned then the tuned on-line model 14c is transferred to the pre-batch model 12c to become that model for the next batch to be made in reactor 18 and the heat exchange coefficient for reactor 18 calculated during on-line phase 14 is used for the next batch. If optimizer 16a determines that the reactor 18 should be cleaned then the tuned on-line model 14c is transferred to the pre-batch model 12c to become that model for the next batch to be made in reactor 18 and the clean heat exchange coefficient for reactor 18 is used for the next batch. Thus the technique 10 will use the tuned on-line model 14c for the prior batch as the pre-batch model 12c for the next batch as long as that model is available.

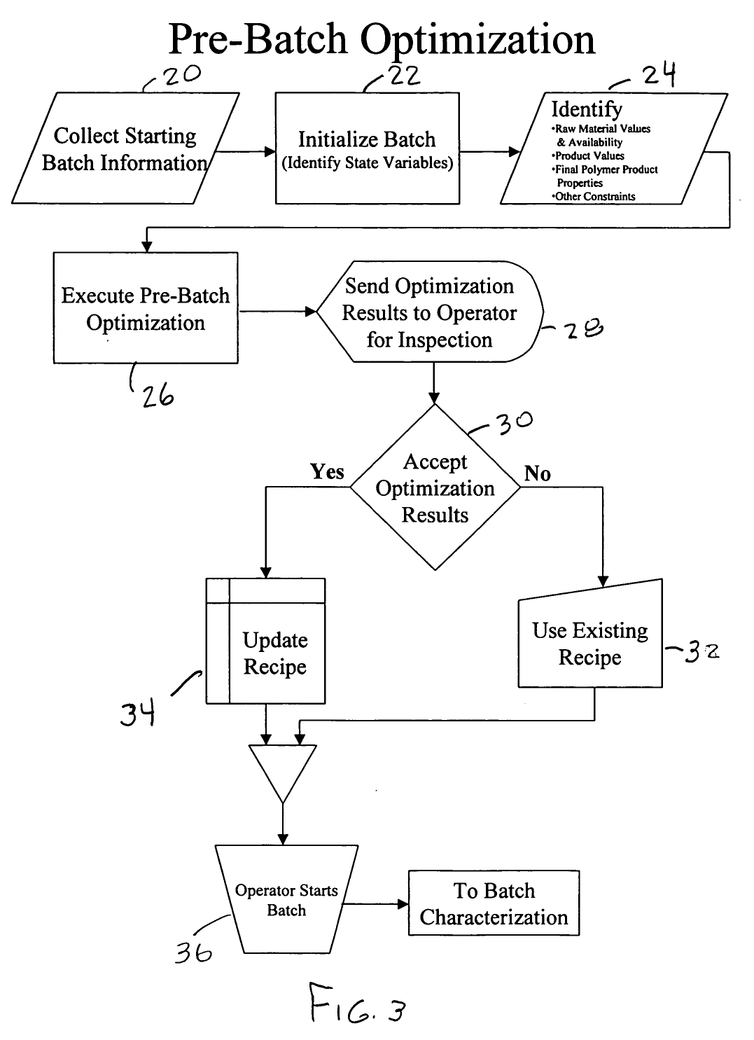

Referring now to FIG. 3 there is shown a complete flowchart for the pre-batch off-line optimization phase 12 of technique 10. Phase 12 starts in 20 with the collection of the starting batch information such as initiator type and quantity available, fresh and recovered VCM properties and availability. The phase in 22 then initializes the batch by identifying the state variables.

The phase then proceeds in 24 to identify the:
a. the raw material values and availablity;
b. the value of the finished polymer;
c. final polymer product properties; and
d. other constraints such as cooling water availability and temperature.

Phase 12 then proceeds to 26 where it executes the optimization of the pre-batch model. The optimization results are then in 28 sent to the operator for inspection. If in 30 the optimization results are rejected the existing recipe is used in 32. If in 30 the optimization results are accepted an updated recipe is used in 34. The operator may accept the optimization results if based on experience the results seem reasonable or the results may be automatically rejected in the event of a failure code from the optimizer such as an over-constrained problem.

After the recipe is selected the batch is started in 36 and the technique enters the on-line phase 14.

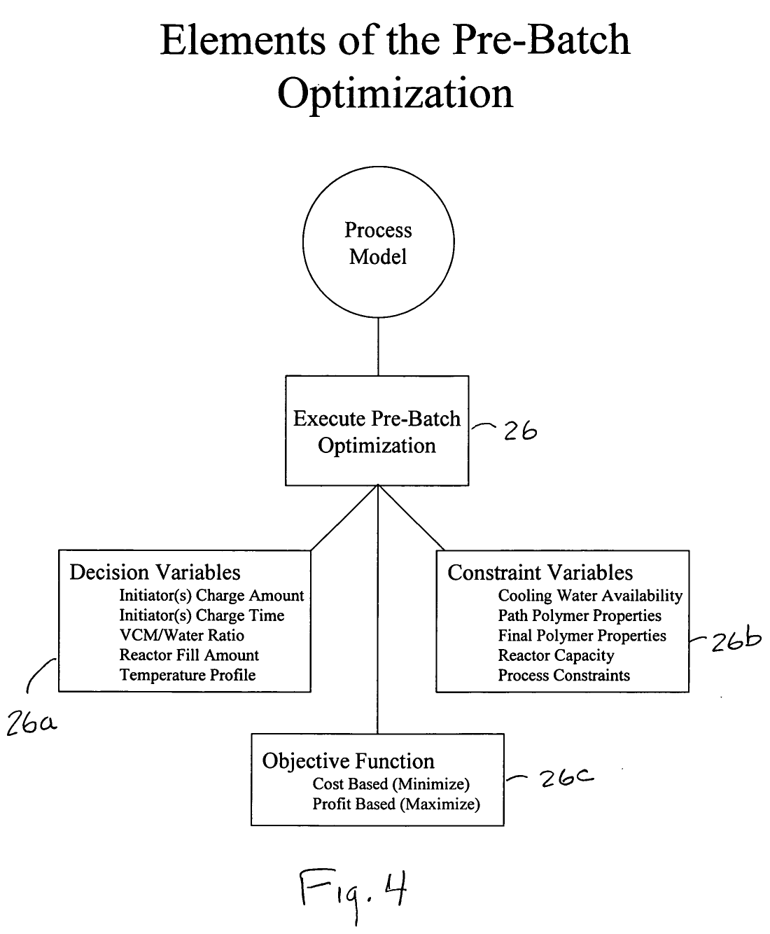

Referring now to FIG. 4, there are shown the elements of the pre-batch optimization 26 in the flowchart of FIG. 3. As is shown in FIG. 4, pre-batch optimization includes the determination in 26a of the decision variables by maximizing or minimizing one of the objective functions of 26c as constrained by the variables identified in 26b. The decision variables include for example the amount of PVC reaction initiator charge and the charge time, the ratio between vinyl chloride monomer (VCM) and water in the reactor 18, and predetermined process conditions such as the reactor fill amount and the temperature profile or any other material charged to the batch such as primary and secondary suspension agents, inhibitors, time and amount of end stop, etc. The constraint variables include the availability of cooling water, the path polymer properties which are the properties of the polymer as it is being developed during the batch and final polymer properties, the capacity of reactor 18 and the process constraints such as pressure, temperature and level. The objective function is the economic objective to be met by the plant for this batch or the polymer produced by the plant. That objective may be either to minimize the cost of the process or maximize the profit from the batch or the polymer.

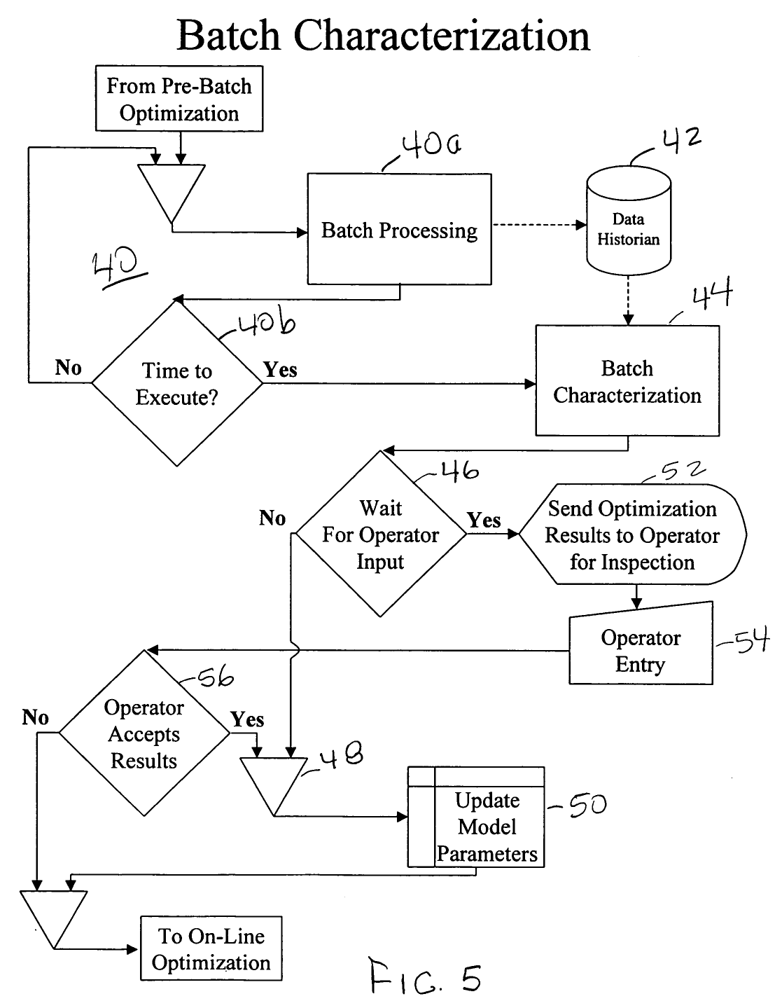

Referring now to FIG. 5, there is shown a flowchart for the batch characterization part of the on-line phase 14 of technique 10. As was described above, since the present invention is concerned with dynamic reconciliation and parameter estimation the corrections are performed by 14a of FIG. 2 only after the process has run for some time as measured from its start, for example, fifteen minutes or one half hour. FIG. 5 shows a loop 40 comprising batch processing 40a and time to execute decision 40b the purpose of which is to allow the process to run from start for a predetermined time before dynamic reconciliation and parameter estimation corrections are performed. If 40b determines that the time to execute has not yet expired loop 40 continues. Data from the batch processing is stored in data historian 42. When decision 40b determines that the predetermined running time has expired the batch is characterized in 44 using the data stored in historian 42.

After the batch is characterized in 44 the technique proceeds to decision 46 where it determines if the operator has the option to either validate the results of the characterization or input different results. If the operator does not have the option the technique proceeds to 48 and then to 50 where the model parameters are updated.

If decision 46 determines that the operator has the option to validate the results or input different results the technique proceeds to 52 where the optimization results are sent to the operator for inspection and then to 54 for operator entry and then to decision 56 to determine if the operator does or does not accept the results. As described above if the operator accepts the optimization results then the model parameters are updated at 50. If the operator does not accept the optimization results then the model parameters are not updated. In either case the technique for the on-line phase proceeds to the on-line optimization 14d.

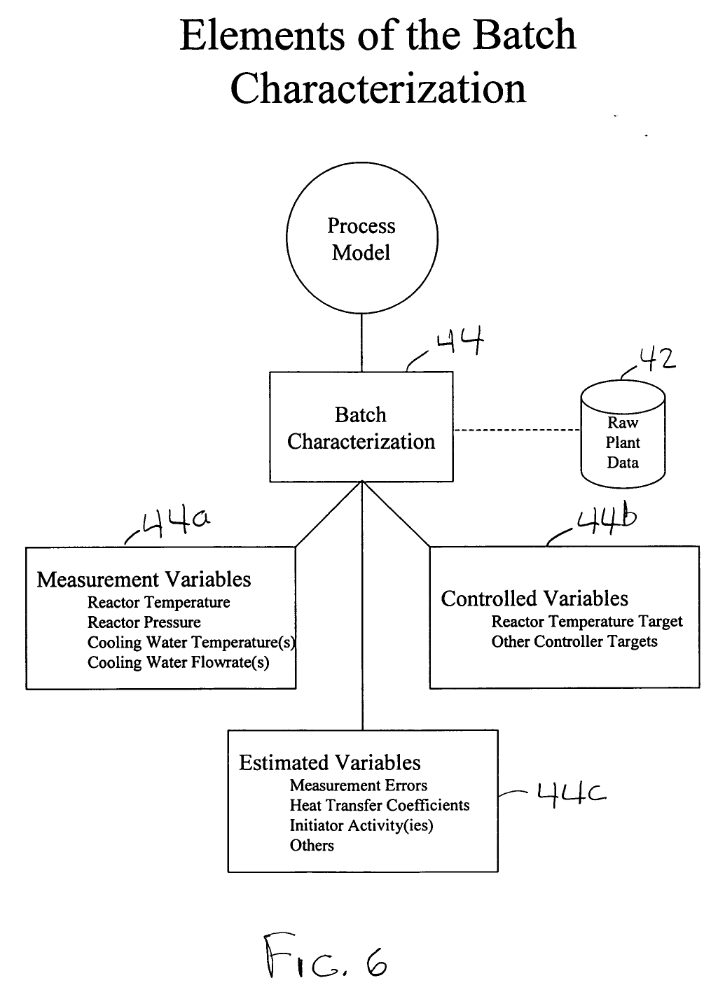

Referring now to FIG. 6 there are shown the elements associated with batch characterization 44 in the flowchart of FIG. 5. As is shown in FIG. 6, batch characterization 44 uses the raw plant data from historian 42 to characterize in 44c the estimated variables in consideration of the measurement variables 44a and the controlled variables 44b. The measurement variables, which are the process response data, include for example the temperature and pressure of reactor 18, and the temperature(s) and flowrate(s) of the cooling water for reactor 18. The controlled variables, which are the changes invoked on the process, include for example the temperature target for reactor 18 and other controller targets. The estimated variables include for example measurement errors, heat transfer coefficients, initiator activity(ies) and other estimated variables.

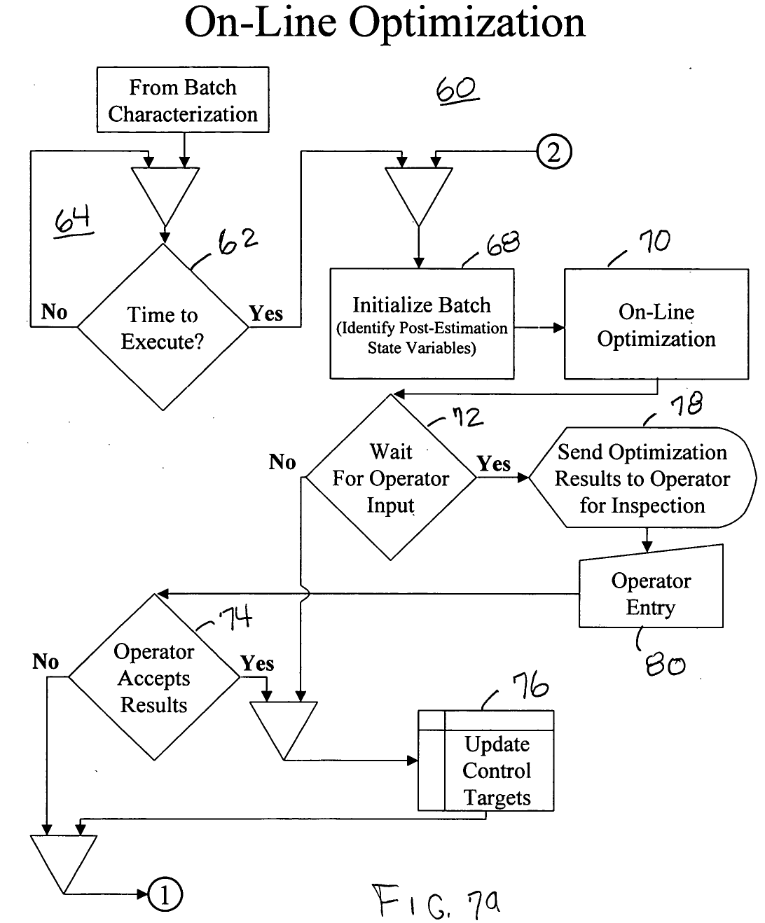

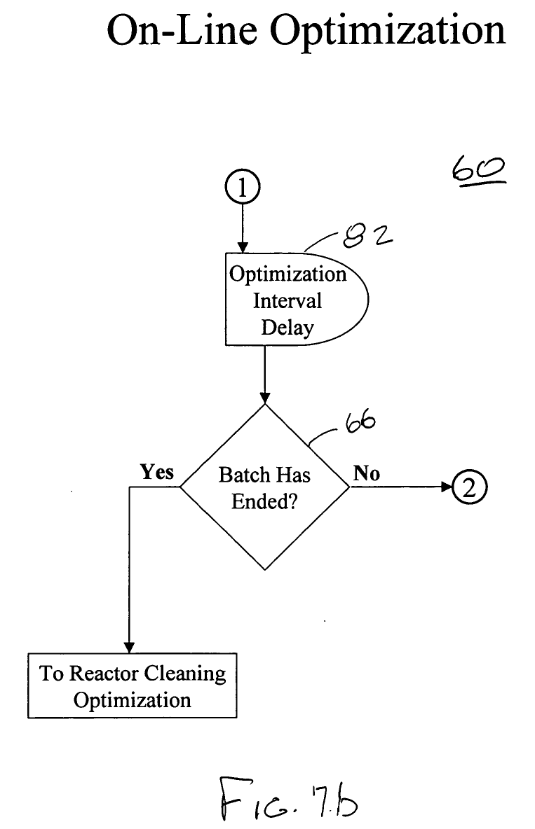

Referring now to FIGS. 7a and 7b there is shown a flowchart 60 for the on-line optimization 14d of on-line phase 14. As was described above in connection with FIG. 2, on-line optimization 14d may be performed one time or periodically scheduled over periodically scheduled over the course of the batch and uses the tuned on-line model 14c. Therefore flowchart 60 which shows a periodic scheduling of the optimization first asks in decision 62 if it is time to execute the on-line optimization 14d. If the answer is no, the technique continues to execute loop 64 until it is time to execute the on-line optimization 14d.

If the answer to decision 62 is yes, the flowchart 60 proceeds to 68 where the post estimation state variables are identified and then to 70 which represents the function of block 14d of FIG. 2 where the on-line optimization is performed. After the on-line optimization is performed, flowchart 60 proceeds to decision 72 where it determines if the operator has the option to validate the results.

If the operator does not have the option, the flowchart 60 proceeds to 76 where the control targets are updated. If the operator has the option, the results of the on-line optimization are at 78 sent to the operator for inspection and at 80 the operator makes an entry to either accept or reject the results.

The flowchart then proceeds to decision 74 where it is determined if the operator has or has not accepted the results of the on-line optimization and as described above to 76 where the control targets are updated if the operator has accepted the results of the optimization. If 74 determines that the operator has not accepted the results of the optimization the flowchart 60 proceeds to 82 in FIG. 7b where there is a delay representing the time interval between periodic execution of the on-line optimization procedure. After the end of the delay, flowchart 60 proceeds to decision 66 where it is determined if the batch is or is not ended. If the batch has not ended, the flowchart 60 returns to FIG. 7a to enter another cycle of on-line optimization. If the batch has ended the technique proceeds to post-batch off-line phase 16 where it is determined as is described below if the reactor 18 should or should not be cleaned before the start of the next batch.

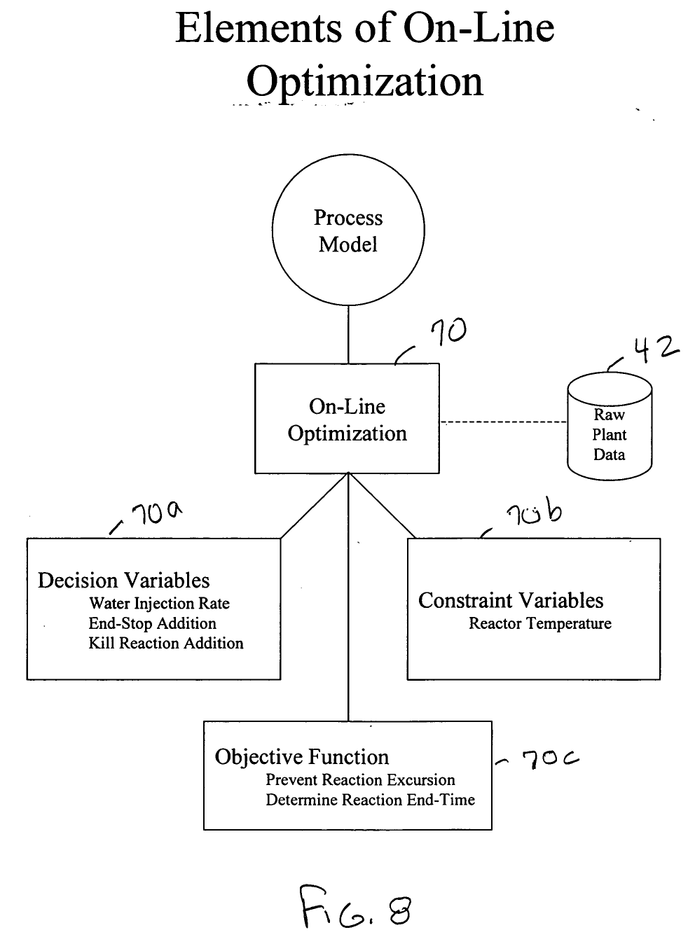

Referring now to FIG. 8, there is shown the elements associated with on-line optimization 70 in flowchart 60 of FIG. 7a. As is shown in FIG. 8, on-line optimization includes the determination in 70a of the decision variables guided by an objective function 70c that is structured to prevent reactor temperature excursions and determine the optimal reaction end-time as constrained by the variables identified in 70b. The decision variables include for example the water injection rate, amount and time of end-stop addition (the addition of an agent to slow the speed at which the batch reacts) and in extreme circumstances the amount of kill reaction addition. The constraint variables include the reactor temperature.

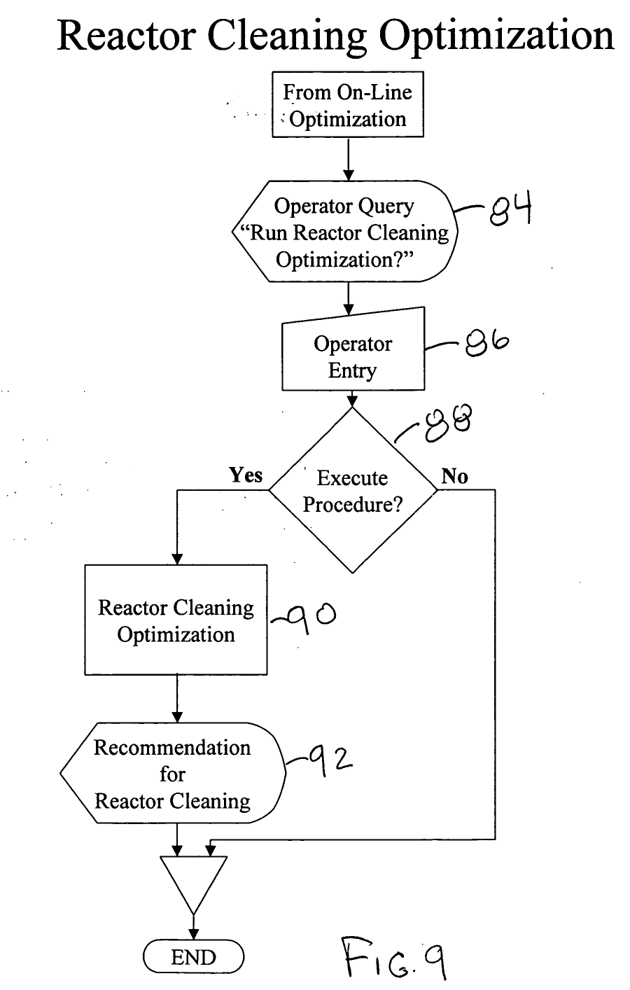

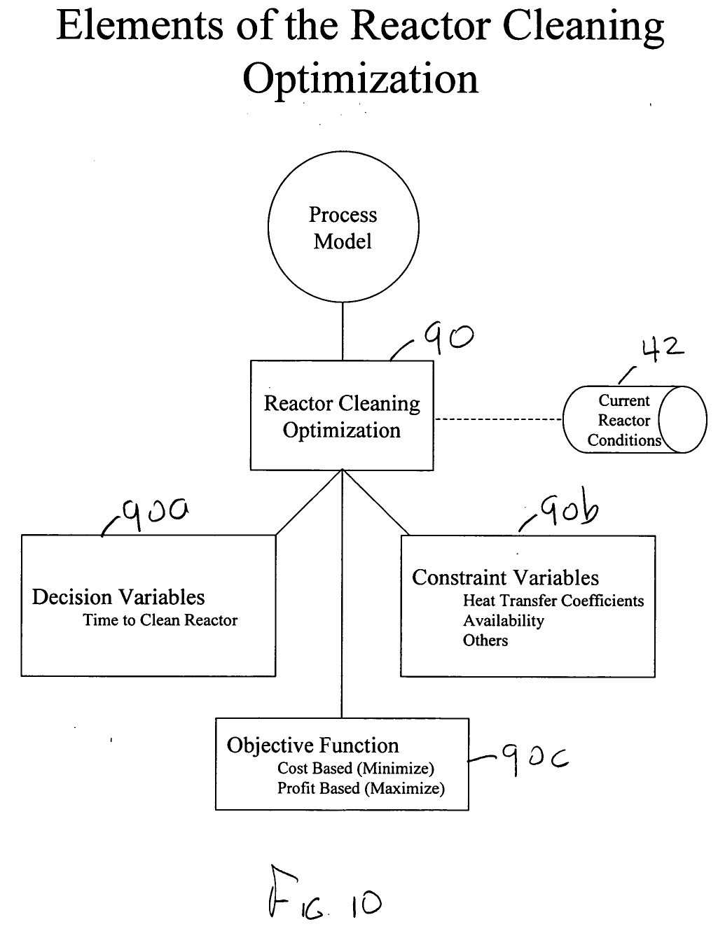

As was described above in connection with FIG. 7b, after decision 66 has determined that the batch in reactor 18 has ended, the technique proceeds to post-batch off-line phase 16. Referring now to FIG. 9, there is shown a flowchart for the reactor cleaning optimization 16a of phase 16. As is shown at 84 the operator is asked if the reactor cleaning optimization should be run. The operator makes an entry at 86 and decision 88 determines if the operator's entry is to run or not to run the reactor cleaning optimization, the elements of which are shown in FIG. 10 to be described below. If the operator's entry is to the reactor cleaning optimization, the technique proceeds to 90 where that routine is run and a recommendation is made in 92 for cleaning of reactor 18.

Referring now to FIG. 10, there is shown the elements of reactor cleaning optimization 90 of FIG. 10. As is shown in FIG. 10, reactor cleaning optimization includes the determination in 90a of the decision variables by maximizing or minimizing one of the objective functions of 90c as constrained by the variables identified in 90b. The decision variables include for example the time to clean the reactor. The constraint variables include for example the heat transfer coefficients and availability of other reactors for producing needed polymer. The objective function is the most favorable economic objective to be met by the plant. That objective may be either to minimize the cost of the plant or maximize the profit from the plant.

While the present invention has been described in connection with the suspension batch production of PVC it should be appreciated that it can be used in other types of batch production of PVC as well as batch production of other polymers. While the present invention is described above in the context of a single batch it should be appreciated that the off-line optimization 12d, the on-line optimization 14d and the reactor cleaning optimization 16a all of FIG. 2 may each be performed simultaneously for one or more than one reactor systems.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

1. In a polymer plant a method comprising:
creating an initial model of a polymer batch process run in said plant;
characterizing said initial model based on past operation of said batch process; and
using said characterized model to perform dynamic optimization of a batch to be run in said polymer batch process.

2. The method of claim 1 wherein said characterized model is used to create a recipe for said batch.

3. The method of claim 1 wherein a recipe for said batch is adjusted using said characterized model.

4. The method of claim 1 wherein said characterized model is used to optimize predetermined process conditions of said polymer batch process.

5. The method of claim 1 wherein said plant has two or more polymer batch processes and two or more reactor systems each of said reactor systems associated with a respective one of said two or more processes and said dynamic optimization is simultaneously performed for said two or more reactor systems.

6. The method of claim 1 wherein said characterized model is used to perform dynamic optimization of more than one batch to be run in said process.

7. In a polymer plant a method comprising:
collecting data from a batch run in a polymer batch process in said plant; and
performing after said data is collected a dynamic reconciliation and parameter estimation for providing both reconciled data and a tuned model for said process.

8. The method of claim 7 wherein said data is collected for a predetermined period of time.

9. The method of 8 wherein said predetermined period of time is from the start of a batch run in said process.

10. The method of 7 wherein said data is collected for multiple periods of time.

11. In a polymer plant a method comprising:
collecting data from a batch run in a polymer batch process in said plant for one or more predetermined periods of time;
initializing from said data and a tuned model for said process the state variables of said batch; and
performing on-line optimization of process variables of said batch run in said process.

12. The method of claim 11 wherein in the event of a predicted temperature excursion in said batch run in said polymer batch process and depending upon the severity of said predicted temperature excursion water injection rate to said batch, optimizing plant variables selected from water injection rate to said batch, addition of an agent to slow the speed at which said batch reacts or an agent to stop said batch reaction.

13. The method of claim 11 wherein said on-line optimization of said process variables determines the end time for said batch run in said process.

14. The method of claim 12 wherein said on-line optimization of said process variables determines the end time for said batch run in said process.

15. In a polymer plant a method comprising:
collecting current conditions of a polymer batch process at the conclusion of a batch run in said process; and
performing an optimization to determine if any of the equipment used within said process should be cleaned.

16. The method of claim 15 wherein said plant has two or more polymer batch processes and two or more reactor systems each of said reactor systems associated with a respective one of said two or more processes and said cleaning optimization is simultaneously performed for said two or more reactor systems.

17. A polymer plant comprising:
a computing device for optimizing a batch run in a polymer batch process in said plant, said computing device either:
for determining optimal performance of said polymer batch process by executing one or more optimizations selected from:
a dynamic optimization of a batch to be run in said polymer batch process;
on-line optimization of process variables of a batch run in said process; and
an optimization to determine if any of the equipment used within said process should be cleaned; or
for performing after data is collected from a batch run in said process a dynamic reconciliation and parameter estimation for providing both reconciled data and a tuned model for said process.

18. The plant of claim 17 further comprising two or more polymer batch processes and two or more reactor systems each of said reactor systems associated with a respective one of said two or more processes.
